(19) United States
(12) Patent Application Publication
(10) Pub. No.: US 2010/0010901 A1
(43) Pub. Date: Jan. 14, 2010

(54) POINT-OF-SALE TRANSACTION MANAGEMENT

(76) Inventors: Charles T. Marshall, Atherton, CA (US); Devin Wade, Seattle, WA (US)

Correspondence Address: Richard Brewster Main, Esq., Patents Pending, 9832 Lois Stiltner Court, Elk Grove, CA, 95624, US

(21) Appl. No.: 12/172,206

(22) Filed: Jul. 11, 2008

(51) Int. Cl. G06Q 30/00; G06Q 40/00

(52) U.S. Cl. 705/17; 705/41

(57) ABSTRACT

A point-of-sale system comprises a webserver that receives lists of products and services offered at retail points of sale, and that can sort them into items that are qualified, conditionally qualified, and non-qualified to be purchased by a cardholder using a flexible spending account payment card. The qualified items are permissible to be purchased by all cardholders, but purchases of conditionally qualified items are only permissible when the cardholder has registered a particular qualifying characteristic. For example, a health condition for which a doctor has prescribed the retail item for purchase. The demographics of the cardholders are available for affinity programs, promotional offers, discounts, and rebates. Such are proffered at the point of sale during transaction authorization to be considered by the cardholder or to be automatically exercised. Purchases in excess of the funds then available in the cardholders' flexible spending accounts can be deducted from other registered accounts or payrolls.

### RELATED APPLICATIONS

This Application claims benefit of U.S. patent application Ser. No. AA/AAA,AAA, entitled, SYSTEM AND METHOD FOR TAX-ADVANTAGED ACCOUNT ADMINISTRATION, filed on Jul. 18, 2006 by Charles Marshall having the same assignee as this application and incorporated herein by reference in its entirety.

### BACKGROUND

1. Field of the Invention

The present invention relates to point-of-sale devices and methods, and more particularly to the real-time management of transactions from a tax advantaged and flexible spending accounts that use payment cards.

2. Description of the Prior Art

Many years ago purchasing departments and employee benefits managers handled all aspects of business purchases of goods and services for their employees. This allowed tight control, but the system was also slow, cumbersome, and not at all responsive to real world needs. So the delivery of such goods and services was sped up by allowing the employees themselves to buy what was needed and then to submit an expense report or claim form. This however also proved to have a new set of problems, including the employee being out-of-pocket, purchases later determined to be unqualified, and fraud. The modern popularity of credit cards, debit cards, and point-of-sales terminals that can do real-time-authorization with the issuing banks of consumer financial transactions lead to other kinds of problems and abuses.

The employees and other uses did not limit themselves to authorized types of purchases, they had cards that were equivalent to cash and nothing outside their own self-control really limmited what they did with the cards. The larger problem was that it was not so clear what exact products and services were qualified expenses, even if the user was trying hard to comply with the rules and limitations. Many expenses need supporting documents to be submitted and retained to validate the expense later when audited or questioned. But since the provider was already paid, the motivation to generate or communicate these supporting documents got lost. Thus valid transactions could be disqualified for a lack of the required supporting evidence.

The Federal Government has complicated the administration of employee health and benefits programs by requiring complex qualifications of goods and services that need an expert to decipher. The rules also change from time to time, and one situation to the next can affect whether an expense is a qualified expense with tax advantages.

Conventional systems can sort out eligibility at a point-of-sale terminal, but there is an entire category of conditional items that are only eligible per other requirements and that are specific to the cardholder. These limitations can usually only be verified by communicating back to verify eligibility. The cardholder may also be eligible for certain promotions, discounts, additional funding sources, credit, etc.

Flexible spending accounts (FSA) can implement employee benefit accounts sanctioned by government authorities that offer tax advantaged employee benefits. Types of flexible spending accounts include those that cover healthcare, transportation, lodging, dependent care expenses, health savings accounts (HSA's), and healthcare reimbursement arrangements (HRA's), etc.

Conventional systems are now used for processing transactions initiated at a retailer or service provider. Many consumers still do not use their flexible spending accounts in over-the-counter transactions because the fielded systems are not configured to process such transactions. Flexible spending accounts have generally required submitting receipts and other paperwork to verify that the purchase was made for an item that was qualified under the flexible spending account. That prompted new systems to be built an auto substantiation function that could determine if a qualified product is being purchased, and thus is entitled to be paid for with funds linked to a flexible spending account card. Unfortunately, sometimes items are only conditionally qualified and can be deductible for only particular pre-qualified cardholders.

What is needed is a way to test if a conditionally qualified item is eligible to be paid for from a particular tax advantaged account, and to manage that in real-time from a point of sale device.

### SUMMARY OF THE INVENTION

Briefly, a point-of-sale system embodiment of the present invention comprises a webserver that receives lists of products and services offered at retail points of sale, and that can sort them into items that are qualified, conditionally qualified, and non-qualified to be purchased by a cardholder using a flexible spending account payment card. The qualified items are permissible to be purchased by all cardholders, but purchases of conditionally qualified items are only permissible when the cardholder has registered a particular qualifying characteristic. For example, a health condition for which a doctor has prescribed the retail item for purchase. The demographics of the cardholders are available for affinity programs, promotional offers, discounts, and rebates. Such are proffered at the point of sale during transaction authorization to be considered by the cardholder or to be automatically exercised. Purchases in excess of the funds then available in the cardholders' flexible spending accounts can be deducted from other registered accounts or payrolls.

An advantage of the present invention is that the retail purchase of products and services only conditionally approved for purchase with tax-advantaged flexible spending accounts is automated.

These and other objects and advantages of the present invention will no doubt become obvious to those of ordinary skill in the art after having read the following detailed description of the preferred embodiments which are illustrated in the various drawing Figs.

### IN THE DRAWINGS

FIG. 1 is a functional block diagram of a point-of-sale (POS) system embodiment of the present invention;

FIG. 2 is a flowchart diagram of a method embodiment of the present invention that can be implemented as computer software to execute on retail POS terminals connected to a webserver over the Internet and related to flexible spending account payment card usage in the system of FIG. 1;

FIG. 3 is a flowchart diagram of a method embodiment of the present invention that can be implemented as computer software to execute on a workstation and manage the registration of retailers and their retail items related to flexible spending account payment card usage in the system of FIG. 1;

FIG. 4 is a flowchart diagram of a method embodiment of the present invention that can be implemented as computer software to execute on a workstation and manage the registration of cardholders, corresponding demographics, and their health conditions related to flexible spending account payment card usage in the system of FIG. 1;

FIG. 5 is a flowchart diagram of a method embodiment of the present invention that can be implemented as computer software to execute on a workstation and manage the registration of employers and their company policies related to flexible spending account payment card usage in the system of FIG. 1;

FIG. 6 is a flowchart diagram of a method embodiment of the present invention that can be implemented as computer software to execute on a workstation and manage the registration of promoters and their incentives related to flexible spending account payment card usage in the system of FIG. 1;

FIGS. 7A-7C are flowchart diagrams of a method embodiment of the present invention that can be implemented as computer software to execute on a workstation and manage the registration of promoters and their incentives related to flexible spending account payment card usage in the system of FIG. 1; and

FIGS. 8A-8B describe a system by all the entities that can be involved and interconnected by a network in support of an FSA POS system.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENT

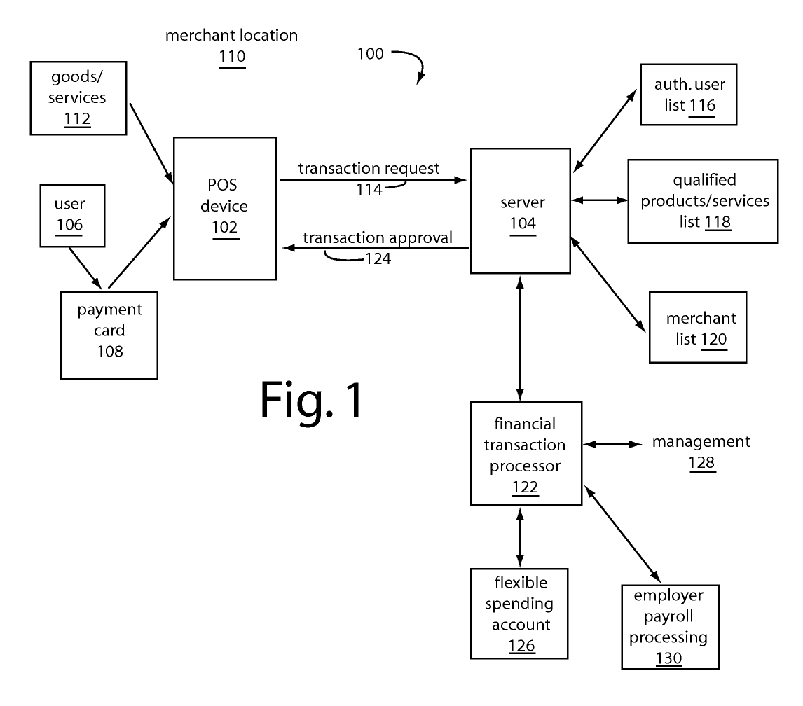

FIG. 1 represents a point-of-sale (POS) system embodiment of the present invention, and is referred to herein by the general reference numeral 100. The POS system 100 may be implemented as a computer program to be sold and installed on otherwise conventional computer systems or financial transaction network workstations, platforms, and hardware that communicate with the Internet. At least one part is installed and executed on a POS device 102 and another part is mounted on a network server 104. Other supporting pieces may be installed or added later throughout the system. In some embodiments of the present invention, the computer programs for system 100 may be sold, licensed, or subscribed to with the aid of disks, downloads, and pre-installations on hard disk or flash memory. Such computer programs for system 100 may be divided into pieces for respective parts of the network.

In a very familiar scenario, a user 106 presents a payment card 108 at a merchant location 110 for payment of goods and/or services 112. A transaction request 114 is transmitted by POS device 102 to the network server 104. The network server 104 consults an authorized user list 116, a qualified goods and services items list 118, a merchant/provider list 120, and a financial transaction processor 122.

If the user, the items, and the merchant/provider are all acceptable, and the funds are on account, then a transaction approval message 124 is returned to the POS device 102. The transactions are logged in a database and the account funds are debited from a corresponding flexible spending account (FSA) 126. Supporting financial transaction details and management controls 128 are made available to company management, accounting, and the government taxing authority. If authorized by the employee, and if necessary to cover overdrafts of the FSA 126, a payroll deduction is sent to employer payroll processing 130. Affinity programs, like frequent flyer miles and club discount cards, can be supported in real-time with appropriate offers and promotions that display at the POS device 102 when the server 104 recognizes a targeted user 106, product/service 118, or class of users and items involved in a present transaction request 114.

In some embodiments of the present invention, the goods and/or services 112 are uniquely identified with industry standard Universal Product Codes (UPC) and/or stock keeping unit (SKU) numbers. These are very often reproduced on labels with bar codes for electronic scanning and POS checkout.

The qualified goods and services items list 118 can include conditionally qualified items that depend, e.g., on who user 106 is and what qualifying characteristics related to the user have been registered and accepted. System 100 is able to verify and authorize the purchase of conditionally qualified items in goods/services 112 from data maintained in the authorized user list 116. FSA 126 is therefore only debited for expenses authorized by the relevant government tax-authority, and is able to automatically discern legitimate buyers for conditionally qualified goods and services.

The remaining drawing Figs. illustrate how individual parts function to contribute to the overall purpose of the system 100.

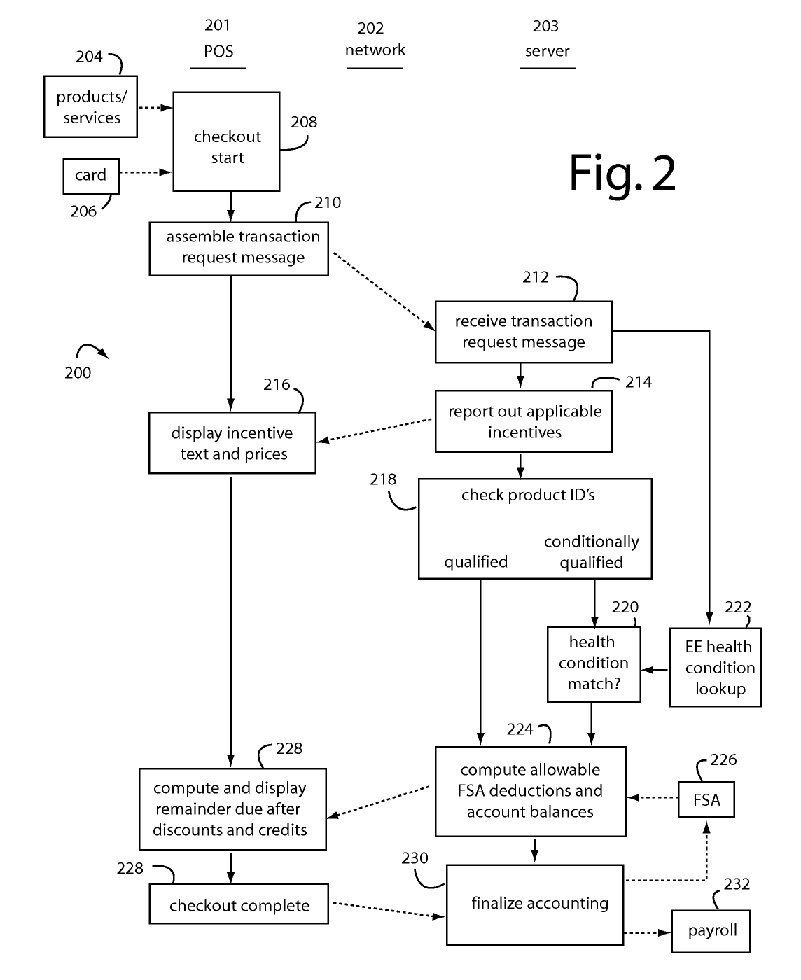

FIG. 2 illustrates a method embodiment of the present invention, referred to herein by the general reference numeral 200. Method 200 includes a retail activity part 201 that operates on a number of POS terminals, and that communicates over a network connection 202 to a server part 203 which operates on a web server. A cardholder begins the process by presenting their FSA card 206 and retail purchase selections of products and/or services 204. These provide machine readable data like magnetic stripes and barcodes that are input by POS device scanners in a step 208. A step 210 assembles a financial transaction request message that includes identification codes for the cardholder, products, services, and merchant, and the retail prices for the products and/or services.

A step 212 receives the financial transaction request message over network 202 and gathers relevant information from its own databases about the cardholder's employer, FSA accounts, health conditions, company policies, and data related to the incentives, products, services, and merchant. A step 214 reports out any applicable incentives given the particulars of this transaction. A step 216 displays the incentive identity, terms, and values for the merchant and cardholder to consider.

A step 218 sorts out those products and/or service items that are qualified or conditionally qualified to be purchased by this cardholder using a corresponding FSA account. If conditionally qualified, a step 220 looks for health condition matches from a health condition lookup 222 that was triggered by step 212. A step 224 computes the incentive discounts, the allowable FSA deductions, and the balances from an FSA account 226. Step 224 summarizes the total for a step 228 which computes and displays the remainder due from the cardholder after all discounts and credits. A step 229 completes checkout at the POS 201. A step 230 finalizes the accounting by adjusting the FSA 226 and debiting any overdrafts of the FSA, as previously authorized by the cardholder, from the cardholder's payroll account 232. Such will appear on the cardholder's next paycheck as a payroll deduction.

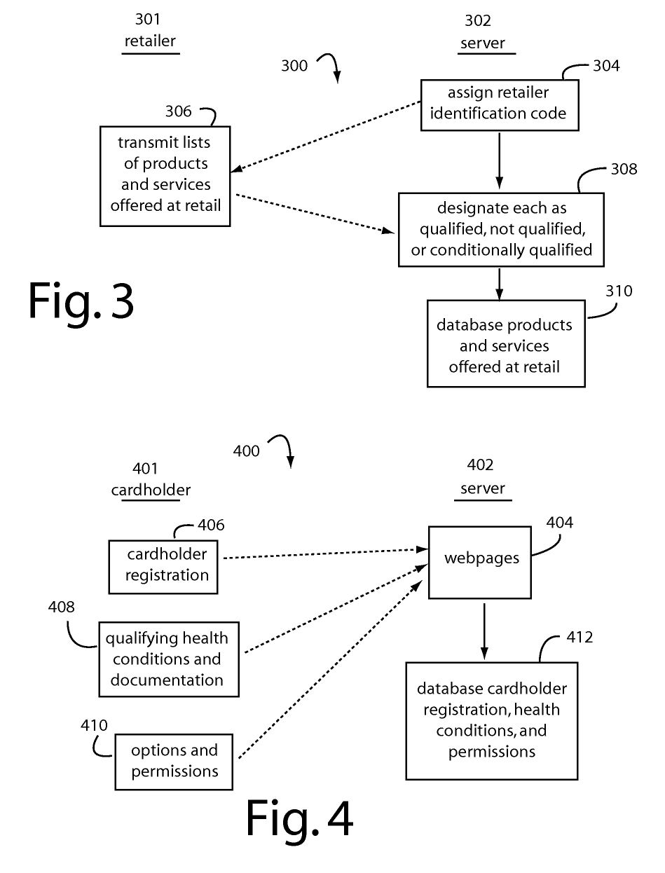

FIG. 3 illustrates a retailer registration method embodiment of the present invention, referred to herein by the general reference numeral 300. Each retailer 301 that will participate in the system 100 of FIG. 1 and the method 200 of FIG. 2 logs into a server 302. A step 304 assigns each retailer 301 a unique identification code, e.g., a merchant code. A step 306 initiated by each retailer 301 transmits lists of the products and services that it offers to FSA cardholders. A step 308 goes through such lists and flags each product or service as qualified, not qualified, or conditionally qualified for purchase with the FSA of the cardholders. A step 310 stores the retail product/service lists and flags in a database. Thereafter, if the server 302 is simply provided the product/service identification code for a POS purchase by a cardholder, a simple lookup can be used to see if the product/service itself is qualified, not qualified, or conditionally qualified for purchase. Such product/service identification codes can also be used by the server 302 to determine if any promotional incentives are activated.

FIG. 4 illustrates a cardholder registration method embodiment of the present invention, referred to herein by the general reference numeral 400. Each cardholder 401 that will participate in the system 100 of FIG. 1 and the method 200 of FIG. 2 logs into a server 402. A step 404 presents a registration webpage on the Internet. A step 406 is used by the cardholder, and perhaps their employer too, to supply identifying information about the cardholder, the employer, the FSA, banking information, etc. A step 408, in particular, provides confidential or sensitive health information about the cardholder that may support the purchase of qualified products using the FSA. A step 410 elicits option selections and permissions from the cardholder, e.g., if payroll deductions are to be permitted and if so what if any limits are to be applied. A step 412 stores all the responses, validations, and supporting documentation in a database. Thereafter, if the server 302 is simply provided the cardholder identification code for a POS purchase by a cardholder, a simple lookup can be used to invoke the corresponding employer policies, health conditions, FSA account, and payroll. Such cardholder identification codes can also be used by the server 402 to determine if any promotional incentives can be appropriately applied.

Each retail product and service is assigned a qualification code that indicates it as being qualified, conditionally qualified, or non-qualified for reimbursement. Qualified products are eligible for reimbursement for any cardholder from tax-advantaged accounts.

Conditionally qualified products are those that may be tax deductable, but only for certain cardholders with particular health conditions. For example, the user must have a health condition with a corresponding an approved use of the product. For example, cardholders with diabetes are approved to buy glucose monitors and supplies.

Non-qualified products are ones that cannot be paid with from funds from a tax-advantaged account. Alcoholic beverages are an example of a product that is never to be paid with from funds from a tax-advantaged account.

Health condition codes are assigned to each user, and qualification codes are assigned to each product. The cardholders and products they are buying have their respective codes matched at the time of purchase. Non-qualified products can be assigned a negative integer, e.g., −1. Qualified products can be assigned a code of zero. And conditionally qualified products can be assigned a whole range of positive integer numbers, and these will align themselves to health condition codes.

For example, a glucose test kit that assesses blood sugar levels may have its product identifier associated with a qualification code-5, e.g., for diabetics. Any cardholders who have established themselves as having diabetes may receive reimbursement from the tax-advantaged account for such products with code-5. Conditionally qualified products may be those meeting government regulations regarding that condition for the tax-advantaged account.

FIG. 5 illustrates an employer registration method embodiment of the present invention, referred to herein by the general reference numeral 500. Each employer 501 that will participate in the system 100 of FIG. 1 and the method 200 of FIG. 2 logs into a server 502. A step 504 assigns a unique employer identification code to each employer 501. A step 506 transmits employer company policies as they relate to the use of cards 206 by employee cardholders and corresponding FSA's. A step 508 abstracts these policies into decision rules that a computer can apply to transaction requests. A step 510 puts these company policies into a database so they can be accessed by employer ID and/or cardholder ID later to make an authorization of a financial transaction.

A company policy, as used in step 506, may consist of a set of guidelines to be applied to purchases related to an employee. For example, a company policy may include limits on paycheck advances, and the type of products for which a paycheck advance may be used. A unique company identifier is assigned for each company, and abstracts of corresponding company policies are stored for each in a relational database.

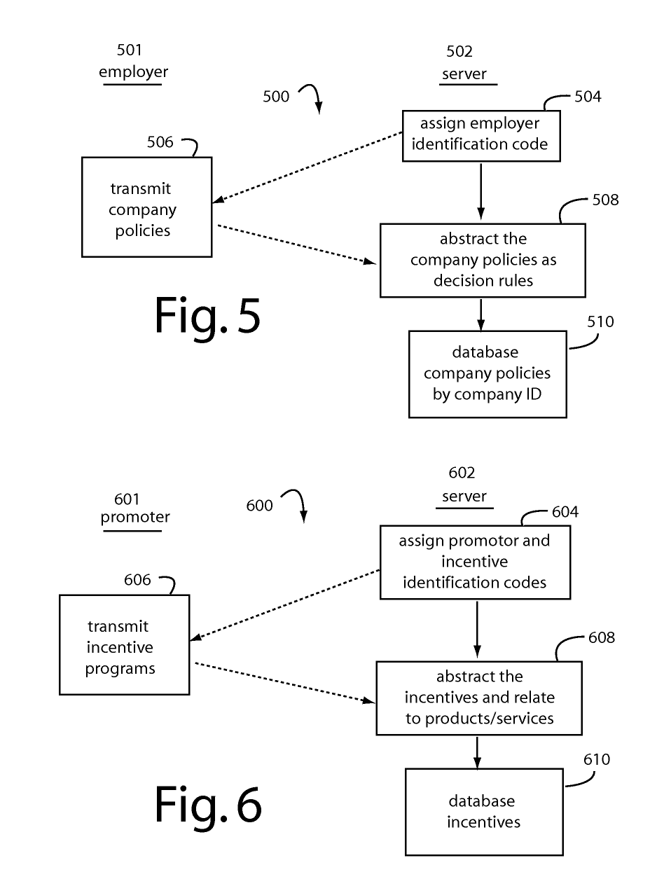

FIG. 6 illustrates a promoter incentive registration method embodiment of the present invention, referred to herein by the general reference numeral 600. Each promoter 601 that will participate in the system 100 of FIG. 1 and the method 200 of FIG. 2 logs into a server 602. A step 604 assigns a unique promoter and incentive number for use later when authorizing a financial transaction.

Incentives are received in step 608 from retailers, manufacturers, health care providers, or other parties. The information for each incentive is stored by step 610. Each incentive may include product and/or retailer identifiers. A discount can be provided by a retailer, or a payment can be made to a retailer if the relevant product is purchased in the transaction at the POS device. The incentive can be restricted to cardholders matching predefined characteristics, e.g., cardholders with particular health conditions, cardholders employed by a certain company, cardholders who are over a certain age, cardholders who are members of a certain gym, etc. A qualification criteria for each incentive specifies the cardholder demographics required for the incentive to apply.

A characteristic may specify that the incentive will be presented in cases in which the product is qualified, or only when a particular condition code is already associated with the cardholder.

Incentives can include discounts from retailers, and payments made to retailers, and can be limited to specific retailers and cardholders. The incentive program can direct that a specific account to be charged for the incentive, and can cap the amounts involved.

Incentive program restrictions may also include, e.g., the first ten employees of a company, a dollar amount, or other criteria. The incentive amount or percentage may also be specified as part of any incentive.

Cardholder affinity identifiers can be used to identify particular cardholders to a retailer, the eligibility conditions for conditional qualifications, and permissions to allow any overages to be deducted from a cardholder's next paycheck.

Returning to FIG. 4, each cardholder may scan in or otherwise submit documentation to support health conditions and other characteristics needed to buy conditionally qualified products or services. For example, proof of a health condition may require a diagnosis from a doctor. The cardholder may access a webpage at a computer web browser to then select one or more conditions from the list of possible conditions.

Conditions are flagged to the system as approved upon receipt of sufficient proof, the actual proof itself is not routinely accessible. In one embodiment, cardholders are selected at random and notified that they must submit proof of the conditions they claim. The conditions for such selected cardholder are not flagged as approved until sufficient proof is received.

If the available balance amount in a tax-advantaged account is exceeded in any one period, and permission has been registered, any overages may be automatically deducted from the cardholder's next paycheck. E.g., by selecting on a browser webpage, a “Please deduct qualified product overages from my next paycheck” option. The cardholder may set a dollar or percentage limit, or the cardholder may otherwise indicate that qualified or conditionally qualified costs that exceed some or all of the balance in the cardholder's flexible spending account may be deducted from the cardholder's next paycheck.

Any health condition information that may have been received at step 408 with documentation from the cardholder are reviewed, and approved or denied. The health conditions, and any submitted documentation, may be reviewed manually, for example, by an outside administrator.

If permission is received to deduct qualified product overages from a cardholder's next paycheck, a paycheck-deduction limit may be designated in step 410. To designate the paycheck-deduction limit, a fixed amount or a percentage of the next paycheck for the cardholder may be designated as the paycheck-deduction limit. For example, the cardholder only allow qualified product overages to be deducted up to the full amount, twenty percent, or $200 maximum of their next paycheck.

The paycheck-deduction limit may be designated up to the limits of and in accordance with company policy information received at step 508 of FIG. 5.

Any approved qualifying conditions and optional paycheck-deduction permissions and thresholds are stored in step 412. It is later associated with the cardholder's tax-advantaged account identifier, optional administrator identifier cardholder affinity card identifiers, any qualifying conditional codes and the optional permission to deduct qualified product overages from the next cardholder paycheck with the paycheck-deduction limit. Any number of cardholders and companies with tax-advantaged accounts can managed by different plan administrators.

Cardholder registration information may be received from a cardholder at any time. Once a cardholder has submitted their registration information, they may be eligible to deduct the cost of qualified products from their tax-advantaged account.

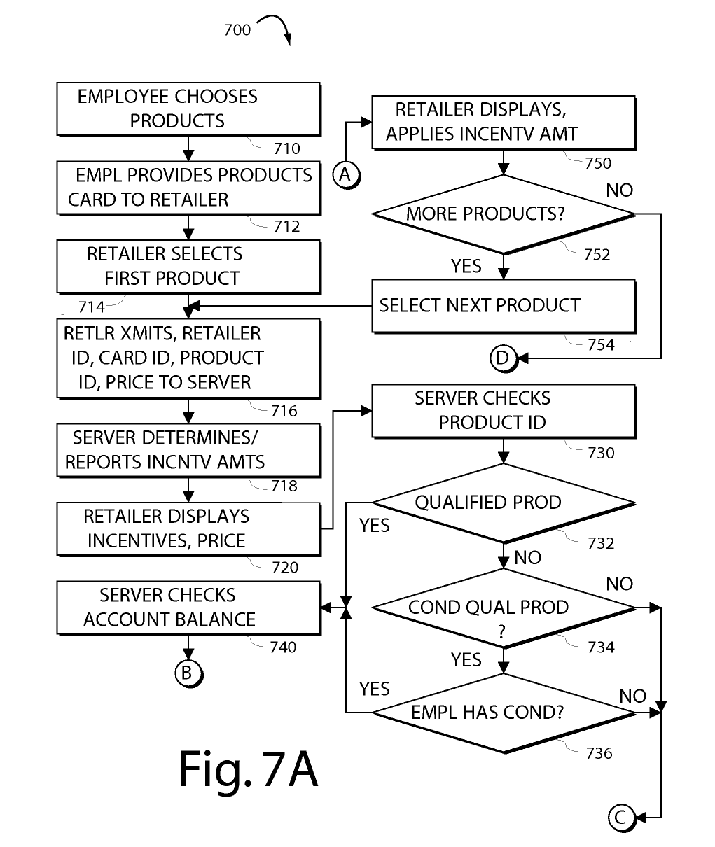

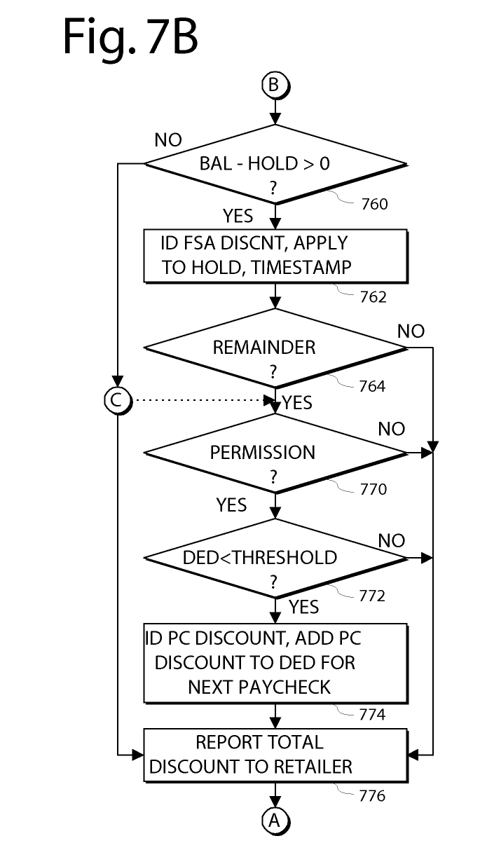

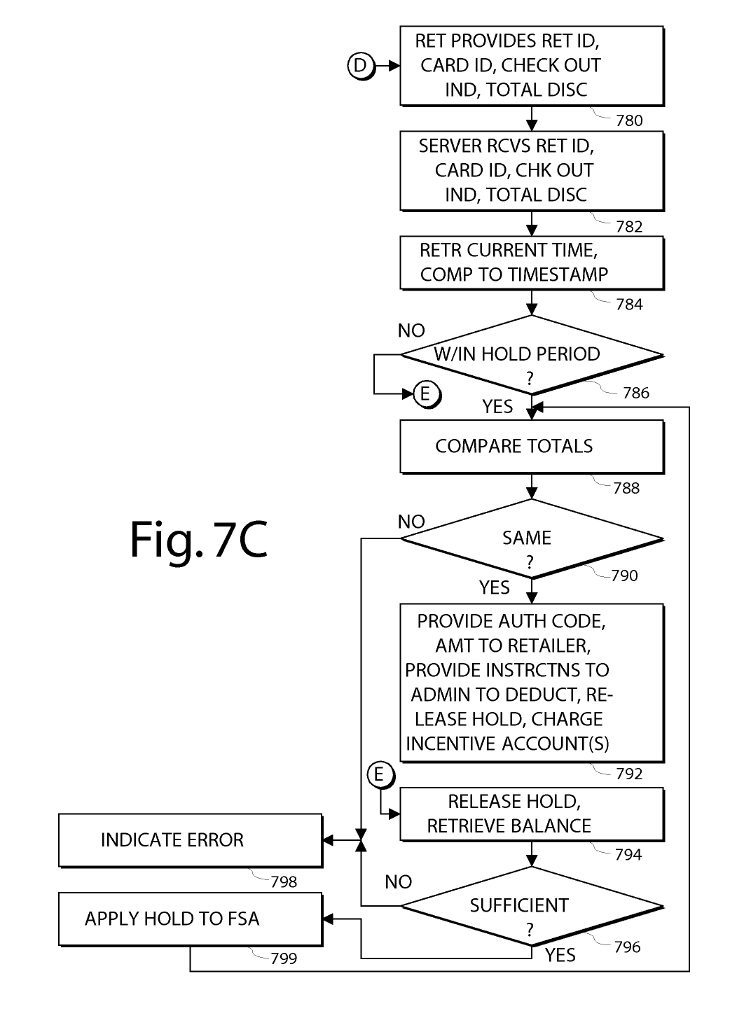

FIGS. 7A-7C represent a method 700 of deducting the cost of qualified and conditionally qualified products from a cardholder FSA according to one embodiment of the present invention. In FIG. 7A, products are chosen in step 710 by a cardholder at a retailer location, such as at a supermarket, pharmacy, or drugstore.

The products chosen and a cardholder affinity card are presented in step 712 at a retailer location. A first chosen product is selected in step 714 by the retailer, for example, using a retailer point of sale (POS) computer system. To select the first chosen product, the retailer may identify the product identifier, such as the UPC or SKU number by scanning or manually entering it.

The retailer identifier, the card identifier of the affinity card provided by the cardholder in step 712 and the product identifier and price of the selected chosen product selected in step 714 are transmitted in step 716 to a server by the retailer, and the information is received in step 716 at the server. To transmit the retailer identifier, the affinity card identifier and the product identifier and price of the selected chosen product, the information may be transmitted over a network such as the Internet and received by the server.

If the product identifier is other than a UPC, the server uses the retailer identifier to look up the product list corresponding to the product code provided. Any applicable incentive or incentives are determined and reported in step 718 by the server from those received. To determine any applicable incentives for the selected chosen product that are applicable to the cardholder, the server may use the retailer identifier, product identifier and the affinity card identifier to determine whether any incentives received apply to the selected product. The affinity card identifier may be used to identify characteristics of the cardholder, such as employer identifier, to determine whether incentives dependent upon cardholder characteristics, apply to the transaction. If the incentive is a discount or payment for cardholders with certain characteristics for products purchased from a certain retailer or retailers, the server determines whether the retailer identifier matches that stored with the incentive, and if so whether the cardholder has all of the characteristics, if any, specified for the incentive, and if so, applies the discount. If the incentive is from a party other than the retailer, and is applicable to any retailer, the server determines whether the product identifier corresponds to any incentives, and if so, whether the cardholder characteristics match all of the characteristics, if any, specified in any such incentive.

The server reports any applicable incentive amounts back to the retailer in any conventional manner, for example over a network such as the Internet. The incentive amount may be a fixed amount or a percentage or other variable amount based on the price of the product, such amount being specified with the incentive. In one embodiment, each incentive may have text associated with the incentive, and such text is provided with the amount of any applicable incentives so that the retailer can display the text at a display screen or on the receipt.

The incentive amounts, and the price of the selected product, minus any reported applicable incentive amount, may be displayed in step 720 by the retailer. Discounts that have been subtracted from the original price are displayed in any conventional manner, such as on a cash register display. The text corresponding to the incentive may also be displayed as part of step 720.

The qualification status of the selected product for the current cardholder is determined in step 754 by the server. To determine the qualification status of the selected product, the UPC of the selected product may be used to retrieve the qualification code or codes associated with the selected product in a qualification table.

If the selected product is a qualified product in step 732, the method continues at step 740 of FIG. 7B. A qualified product is a product that is eligible to be deducted from a tax-advantaged account, if the product is designated as a qualified product without conditions. The selected product may be determined to be a qualified product without conditions if the qualification code associated with the selected chosen product is zero.

If the selected chosen product is not a qualified product in step 732, but the selected chosen product is a conditionally qualified product in step 734 for which the account holder qualifies in step 736, the method continues to step 740. The selected product may be determined to be a conditionally qualified product if the qualification code or codes associated with the selected chosen product include any positive number.

The cardholder is assumed to qualify for the conditionally qualified product if the code for any required condition for that product has been stored as part of the cardholder registration information for the cardholder. For example, if a cardholder is approved and documented as being a diabetic, the cardholder may be conditionally qualified for one or more products eligible to be deducted from the tax-advantaged account of a cardholder who is a diabetic, e.g., a kit for testing a cardholder's blood sugar levels. A cardholder has the condition for which a product is qualified if the condition code of the product matches or corresponds to the same code in the cardholder information.

Otherwise, if the selected chosen product is neither a qualified product in step 732 nor a conditionally qualified product in step 734, or if the selected chosen product is a conditionally qualified product in step 734 for which the cardholder is not qualified in step 736, the method continues to step 776 of FIG. 7B.

At step 740, the balance of the cardholder tax-advantaged account is checked by the server. To check the balance of the cardholder tax-advantaged account, the identifier of the affinity card or credit card provided by the cardholder at step 712 may be used to request and receive the account number and administrator identifier of the cardholder tax-advantaged account. The account number is sent to a server operated by that administrator, and the balance of that account is received. The administrator is a third party, an entity different from and not majority owned by, or not a majority owner of, the party that performs step 740, or the administrator of the account the same party as the party that performs step 740, or a party that controls or is controlled by that party.

In one embodiment, to the extent that funds are available in the tax-advantaged account, if the product is qualified for the cardholder, either because the product is unconditionally qualified, or the product is conditionally qualified for the condition the employee has, the amount of those funds, up to the remaining price of the product, is reported as a further discount to the retailer so that the retailer can properly compute the remainder, if any, which is the amount the cardholder must pay for the product, and may optionally display these amounts to the cardholder. The amount of the funds to apply from the tax-advantaged account is reported as a further discount, referred to as the tax-advantaged account discount, in a manner similar to the incentives described above. This allows the retailer to separately print or display both the incentive amount and the amount applied from the tax-advantaged account, yet treat them both as a discount to the purchase price of the product, to be deducted from the price to be charged the cardholder at the point of sale terminal.

A hold is placed on the tax-advantaged account in the amount of the tax-advantaged account discount until the retailer confirms that the check out process is complete. The product is recorded as having been purchased and the tax-advantaged account is charged for the product when the product identifier is received. In the event that the check out process is not completed, the transaction is reversed from the tax-advantaged account.

In FIG. 7B, if the balance of the cardholder tax-advantaged account minus any hold amount currently corresponding to the cardholder tax-advantaged account is greater than zero in step 760, the tax-advantaged account discount applicable to the selected chosen product is identified. The amount of the tax-advantaged account discount is added as a hold amount for the cardholder tax-advantaged account, and the current time and date is added to the hold amount in step 762. To identify the amount of the tax-advantaged account discount, either the price of the selected chosen product reported and displayed at step 718 and 720 of FIG. 7A. The full price minus any retailer discounts is identified as the tax advantaged account discount, or if that price is greater than the balance minus the hold amount left in the cardholder tax-advantaged account, the remainder of the balance minus the hold amount is identified as the tax-advantaged account discount.

For example, if a selected product that costs twenty dollars is eligible to be deducted from the cardholder tax-advantaged account, and the total balance of the cardholder tax-advantaged account exceeds twenty dollars, then the tax advantaged account discount is the full price of the product, or twenty dollars. However, for that same twenty-dollar selected product, if the total remaining balance of the cardholder tax-advantaged account is only ten dollars, then the tax-advantaged account discount is set to ten dollars.

The identified tax-advantaged account discount amount is added to a hold amount on the cardholder tax-advantaged account. It may not be deducted from the actual tax-advantaged account. For example, in case the cardholder changes their mind about purchasing the product at a later time before completing check out.

The transaction is stored, and includes the product identifier, cardholder identifier, incentives, and tax-advantaged account discount to apply to the product price, the current time and date. The identifier of each incentive may be added at the time the information regarding the incentive is stored.

If there is a remainder in step 764 after the tax-advantaged account discount has been applied to the hold amount on the cardholder tax-advantaged account, such remainder being the balance of the tax-advantaged account minus the hold amount on the tax-advantaged account is not sufficient to cover the full cost of the selected product, permission may have been recorded for the cardholder at step 236 of FIG. 2B to deduct any qualified product overages from the cardholder's next pay check.

If permission was recorded in step 770, and the amount of the paycheck deduction does not exceed the paycheck deduction limit identified for the cardholder at step 234 of FIG. 2B or any limit set forth in the company policy for the company corresponding to the company identifier of the cardholder, the remainder, to the extent either paycheck-deduction limit has not been exceeded, may be calculated in step 774 as a paycheck discount for the cardholder. The amount of the paycheck discount is added in step 774 to a deduction amount to be applied to the cardholder's next scheduled paycheck.

If a product is not qualified and not qualified for the cardholder, the entire amount of the purchase price for such product is treated as an overage. As illustrated by the dotted line from connector-C to step 770 of FIG. 7B, such overages for non-qualified products for the cardholder may be deducted from future cardholder paychecks, in the manner described above, even if the products are not qualified products.

In step 776, any applicable incentive, tax-advantaged account, and paycheck discounts are reported by the server to the retailer. The total discount is reported by the server to the retailer over a network such as the Internet. The price, UPC code corresponding to the product identifier, transaction identifier, amount of any discounts, and the account number of any incentives, are stored as a pending product record, along with a transaction identifier and an order identifier for all products purchased together by the cardholder.

The final price of the selected chosen product is displayed in step 750 by the retailer. To display the final price of the selected chosen product, the retailer may display and/or apply the discount or discounts for the selected product received from the server and/or display the original price of the selected product.

If the cardholder has provided no more chosen products to the retailer that the retailer has not yet selected and transmitted to the server in step 752, the method continues to step 780 of FIG. 7C.

Retailers may provide identifiers of products one at a time, to allow the price and discounts to be displayed as they are rung up. However, rather than receiving and providing the information described herein for each product at a time, the same process may be performed with the retailer providing the product identifiers several at a time, for example, after the products have been scanned but before they have been paid for.

Paycheck discounts can be totaled, but not applied until the cardholder enters a personal identity number (PIN). The cardholder can also enter an amount to be used for the paycheck discount if less than all of the eligible amount is to be used. The retailer may receive the PIN and optionally, the amount, and provide it to the server for this purpose.

To identify the products that correspond to a single order, an order identifier may be provided by the retailer for each product that is part of an order, the order identifier being originated by the retailer or by the party receiving the product identifiers. Other ways of identifying a single order may be used, such as using the source Internet Protocol (IP) address and port identifiers that may be provided with the product identifiers. The retailer can handle the provision of a separate IP address and port, either by providing one for each cash register, either directly or using a type network address translation function provided by a server, in which the server uses a different IP address and port identifier to identify each currently pending order. The operation of the method by the retailer may only require minimal additional programming. A watchdog timer, or an indication that a product identifier is the first of an order, can be used to detect problems, such as when a cash register is being reset in a manner in which product identifiers from a previous order may be retransmitted from the retailer.

If the cardholder has provided one or more chosen products to the retailer that the retailer has not yet selected and transmitted to the server in step 752, the retailer selects the next chosen product in step 754, and the method continues at step 716 with the newly selected chosen product.

FIG. 7C continues from FIG. 7B, and illustrates a method of deducting qualified expenses from a cardholder tax-advantaged account. If the retailer has scanned the last product chosen by the cardholder in step 752, the retailer identifier and the cardholder affinity card identifier are transmitted in step 780 to the server by the retailer, along with a check-out indication and the total amount of the expected discounts that the retailer expects to receive from those described above. The check-out indication may be transmitted as flag, for example a “calculate total” flag. The transaction identifier is also included or implied.

The retailer identifier, the cardholder affinity card identifier, the check out indication, the total expected discount and the transaction identifier are received in step 782 at the server. The current date and time are retrieved in step 784, and the retrieved date and time are compared in step 784 to the date and time of the first time-stamped transaction that is recorded for the cardholder for the transaction identifier. If the date and time of the check out attempt is not within a specified hold period in step 786, the method continues in step 794. The hold period may be a length of time specified by the tax-advantaged account administrator of the cardholder tax-advantaged account corresponding to the cardholder affinity card identifier, or the hold period may be specified by another administrator.

If the date and time of the check out attempt is within the specified hold period of the current date and time in step 786, the current check out total expected discount received from the retailer is compared in step 788 to the total expected discount calculated at the server. The total expected discount is calculated at the server as the summation of all discounts applicable. If the two expected discount totals are not the same in step 790, an error is indicated to the retailer in step 798.

If the two expected discount totals are the same in step 790, the total discount is returned in step 792 to the retailer along with an authorization code and the current date and time.

The authorization code is provided to the retailer with the current date and time so that the retailer may optionally store the information for its records.

In step 792, an instruction is sent to the administrator of the cardholder tax-advantaged account to deduct the appropriate amount from the cardholder tax-advantaged account and to release the hold on the cardholder tax-advantaged account. The total expected tax-advantaged account discount for the transaction, which does not include any expected deductions from future cardholder paychecks, is provided with the authorization code to the tax-advantaged account administrator with an instruction to deduct that amount from the cardholder tax-advantaged account. The tax-advantaged account administrator is instructed to release the hold corresponding to a current transaction that had previously been placed. Any incentive accounts are charged for incentives corresponding to the order, as part of step 792, using an order number from pending product records.

A hold on the tax-advantaged account may expire. This allows a transaction that is interrupted without completion to be automatically released. Step 794 is used when the hold has expired before the transaction is complete.

In step 794, the account administrator is messaged to release the hold on the tax-advantaged account, and the current balance of the cardholder tax-advantaged account is again retrieved from the tax-advantaged account administrator. The hold is released and the current balance is retrieved to ensure that sufficient funds are still available in the cardholder tax-advantaged account to cover the costs that are to be deducted from the cardholder tax-advantaged account. For example, to ensure that other transactions are not concurrently being deducted from the cardholder tax-advantaged account, that would result in insufficient funds. If the newly retrieved balance of the cardholder tax-advantaged account is not sufficient to cover the deductions expected from the current transaction in step 796, an error is sent to the retailer in step 798.

If the newly retrieved balance of the cardholder tax-advantaged account is sufficient to cover the deductions expected from the current transaction in step 796, the tax-advantaged account administrator is requested in step 799 to put a new hold on the cardholder tax-advantaged account. The method continues to step 788.

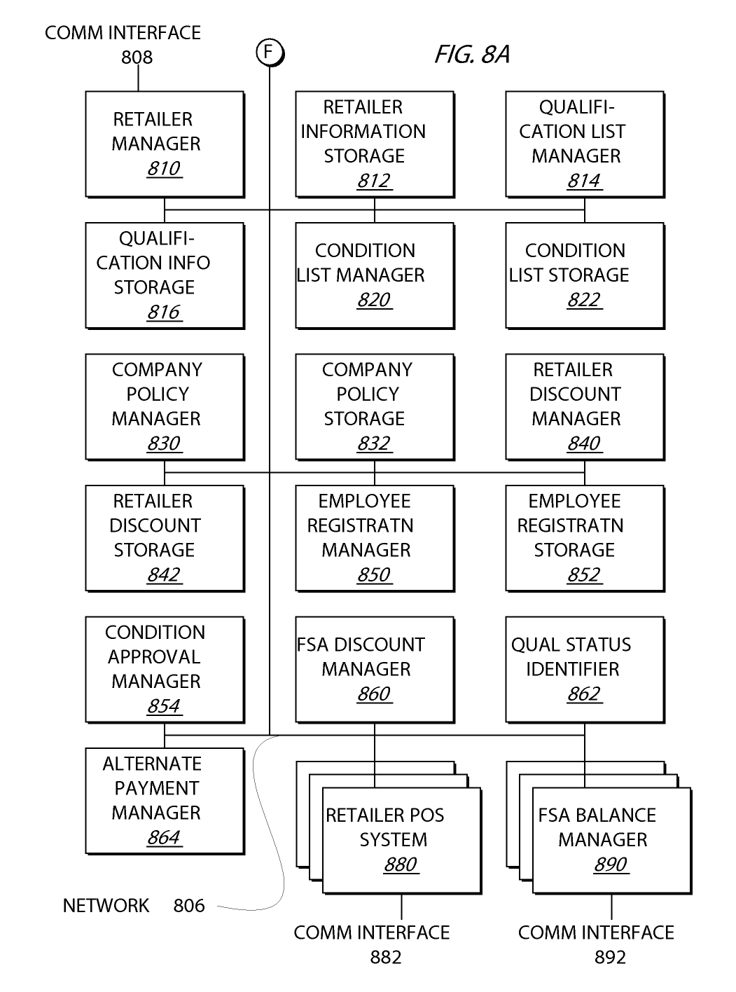

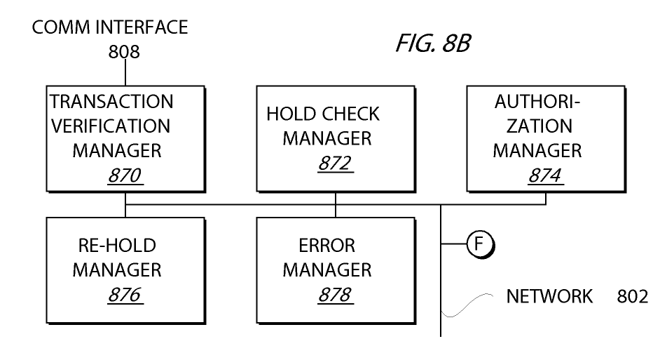

FIGS. 8A and 8B describe a system 800 by all the entities that can be involved and interconnected by a network 802. A communications interface 808 is private to a retailer manager 810. System 800 further includes a retailer information storage 812, a qualification manager 814, a qualification information storage 816, a health condition list manager 820, a health condition list storage 822, a company policy manager 830, a company policy storage 832, a retailer discount manager 840, a retailer discount storage 842, an employee registration manager 850, an employee registration storage 852, a health condition approval manager, a flexible spending account (FSA) discount manager 860, a qualification status identifier 862, an alternate payment manager 864, a transaction verification manager 870, a hold check manager 872, an authorization manager 874, a re-hold manager 876, an error manager 878, a plurality of retailer POS terminal systems 880, and an FSA balance manager 890. Special communication interfaces 882 and 892 are provided for secure communications.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A cardholder benefits system, comprising:
a device to access a flexible spending account (FSA);
a database for storing a list describing a vendor inventory of products and services;
a database for storing a non-qualified set of products and services represented in the list that are not qualified to be purchased by a cardholder using the FSA;
a database for storing a conditionally qualified set of products and services represented in the list that are may be qualified to be purchased by a cardholder using the FSA if predefined conditions are satisfied;
a database for storing an always-qualified set of products and services represented in the list that are always qualified to be purchased by a cardholder using the FSA;
a product code that identifies a particular one of said set of products and services as belonging to one of the non-qualified set, the conditionally qualified set, or the always-qualified set; and
a point of sale (POS) device for using a code that identifies a characteristic of a cardholder to decide if a product or service in the conditionally qualified set can be bought at a POS using the FSA.

2. The cardholder benefits system of claim 1, further comprising:
a device to register a paycheck deduction authorization if the FSA has insufficient funds available.

3. The cardholder benefits system of claim 1, further comprising:
a webserver that receives lists of products and services offered at retail points of sale, and that can sort them into items that are qualified, conditionally qualified, and non-qualified to be purchased by a cardholder using a flexible spending account payment card.

4. The system of claim 1, wherein, cardholder purchases of conditionally qualified items are permitted only when a cardholder has registered a particular qualifying characteristic.

5. The system of claim 1, wherein, at least some demographic of said cardholders is available for affinity programs, promotional offers, discounts, and rebates.

6. The system of claim 1, wherein, affinity programs, promotional offers, discounts, and rebates are proffered at said POS device during transaction authorization, so as can be considered by said cardholder or are automatically exercised.

7. The system of claim 1, wherein, purchases in excess of any funds then available in a cardholder's flexible spending account is deducted from other registered accounts or payrolls.

8. A point-of-sale method, comprising:
accessing a server from a remote point-of-sale (POS) location in response to being presented with a payment card from a flexible spending account (FSA) cardholder;
categorizing health conditions for which products and/or services which the cardholder must have to be qualified for reimbursement from a FSA, and any conditions each particular cardholder may have;
checking for any promotions, discounts, credit, and funding, that are particularly directed to said cardholder specifically or by classification;
verifying any eligibility of an item before being reimbursed from a tax advantaged account that is presented for purchase by said cardholder at said POS location;
wherein, only items eligible per other requirements and are specific to the cardholder that can only be verified by communicating back to our servers to check for the other requirements and verify eligibility and return that to the merchant/provider POS

9. The point-of-sale method of claim 8, further comprising:
collecting incentive information related to products and/or services that offer a discount or incentive for purchasing that product or service.

10. The point-of-sale method of claim 8, further comprising:
supplying a code to identify if an item qualifies for reimbursement using a cardholder's tax-advantaged account, and any extent to which such reimbursement may be made from it.
